(19) United States
(12) Patent Application Publication
(10) Pub. No.: US 2025/0022390 A1
(43) Pub. Date: Jan. 16, 2025

(54) DECORATIVE DOOR COVER/BANNER

(71) Applicant: Zohar Harel, Orlando, FL (US)

(72) Inventor: Zohar Harel, Orlando, FL (US)

(21) Appl. No.: 18/899,080

(22) Filed: Sep. 27, 2024

(51) Int. Cl. G09F 17/00; F21V 21/08; G09F 13/00

(52) U.S. Cl. CPC G09F 17/00; F21V 21/0832; G09F 13/00

(57) ABSTRACT

A decorative door cover/banner is formed of a lightweight polyester material and includes a graphics image on a front face. The decorative cover/banner is specifically designed, sized and configured for attachment to the outside of a garage door or a front door of a house or building. An inside face of the decorative cover/banner includes a spaced arrangement of cooperating hook and loop fastener components along a top portion for allowing removable attachment of the decorative cover/banner to the top portion of the garage door or front door. One component of the hook and loop fastener components is removable and includes a peel away film with an adhesive for attaching the hook or loop fastener component to the top portion of the garage door or front door.

### FIELD OF THE INVENTION

The invention pertains to systems and methods for securing decorative covers that can be temporarily affixed to hinged panel doors, such as a typical garage door, without the need for hardware fasteners that penetrate the door and permitting normal operation of the door.

### DESCRIPTION OF THE RELATED ART

Known systems for securing decorative covers to hinged panel doors typically call for complex mechanical systems that either deform the door in some manner, such as a screw aperture, or interfere with operation of the door, preventing it from hinging or from being stowed. The present invention presents solutions to these and other problems persistent in the art.

### SUMMARY OF THE INVENTION

A decorative door cover/banner is formed of a lightweight polyester material and includes a graphics image on a front face. The decorative cover/banner is specifically designed, sized and configured for attachment to the outside of a garage door or a front door of a house or building. An inside face of the decorative cover/banner includes a spaced arrangement of cooperating hook and loop fastener components along a top portion for allowing removable attachment of the decorative cover/banner to the top portion of the garage door or front door. One component of the hook and loop fastener components is removable and includes a peel away film with an adhesive for attaching the hook or loop fastener component to the top portion of the garage door or front door. The cooperating component of the hook and loop fastener remains on the back side of the decorative cover/banner. The spaced arrangement of cooperating hook and loop fastener components along the top of the door and the back side of the decorative cover/banner are positioned in alignment for allowing removable attachment of the cover/banner to the door. Three elastic cords are secured to a bottom edge of the decorative cover/banner and include a hook on a distal end of each cord. The elastic cords are passed under the bottom edge of the door and hooked onto the inside of the garage door on the first (lowermost) hinge of the door, at the opposite ends and also the center of the door. In a further embodiment, one or more string lights containing multiple LED lights is provided on the decorative cover/banner to enhance the overall decorative image. The LED lights are powered by a battery pack and controller which is contained within a pocket on the inner facing side of the decorative cover/banner. Additionally, a remote control is provided that wirelessly communicates with the controller to allow the lights to be turned on and off, as well as changing the flashing sequence and colors of the lights using the remote control.

The use of the hook and loop fastener components, the elastic cord with hooks, and the lightweight polyester material of the decorative cover/banner allow for easy and fast attachment and removal of the decorative cover/banner from a garage door, while allowing the garage door to open and close with no obstruction. Additionally, the use of the hook and loop fastener components and the elastic cord with hooks eliminate the need for hardware fasteners that penetrate the garage door or front door and damage the door.

### BRIEF DESCRIPTION OF THE DRAWINGS

For a fuller understanding of the nature of the present invention, reference should be had to the accompanying drawings in which:

FIG. 1 illustrates a series of steps of installation of the decorative door cover/banner of the present invention;

FIG. 2 is an exploded perspective view showing the back side of the decorative door cover/banner in relation to a garage door, and a separated image of the cooperating hook and loop fastener components that are provided on the back side of the cover/banner for removably attaching the cover/banner to the top portion of the garage door;

FIG. 3 is a perspective view showing the decorative cover/banner of the present invention being attached to the garage door with the use of the cooperating hook and loop fastener components;

FIG. 4 is a perspective view showing the decorative cover/banner being secured to the door with the hook and loop fastener components as the user presses against the top portion of the decorative cover/banner on the outside to secure the cooperating hook and loop fastener components together;

FIG. 5 is a perspective view showing the inside of the garage door, in the closed position, with the hooks on the ends of the elastic cords secured to the first, lowermost hinge of the garage door, at the opposite ends and the center of the door;

FIG. 6 is an isolated perspective view showing the hook on one of the elastic cords secured to the bar of the lowermost hinge of the garage door; and

FIG. 7 is a front elevational view showing the decorative graphics image on the decorative door cover/banner of the present invention revealed on the outside of the garage door with the garage door in the closed position.

### DETAILED DESCRIPTION OF THE PREFERRED EMBODIMENT

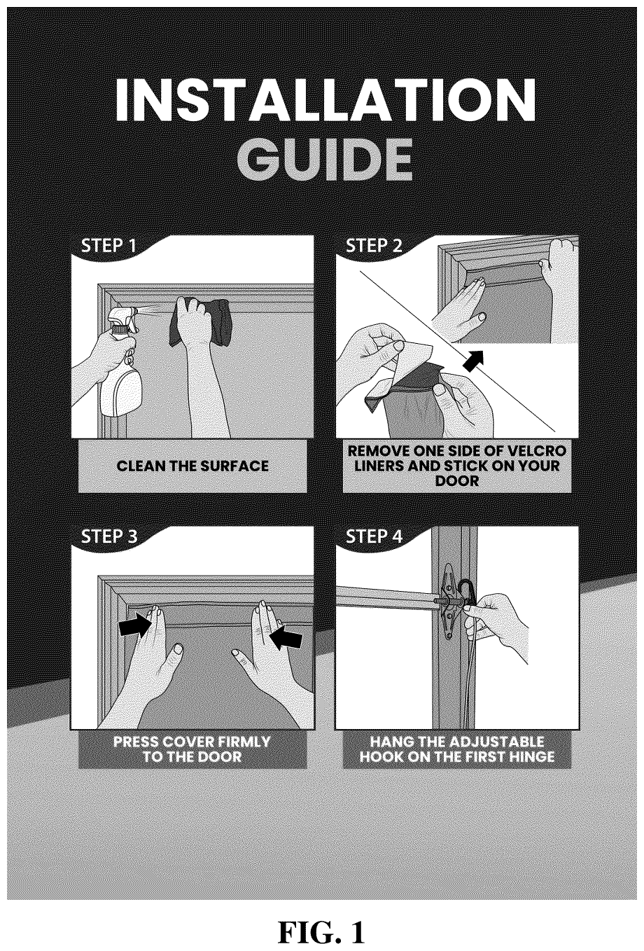

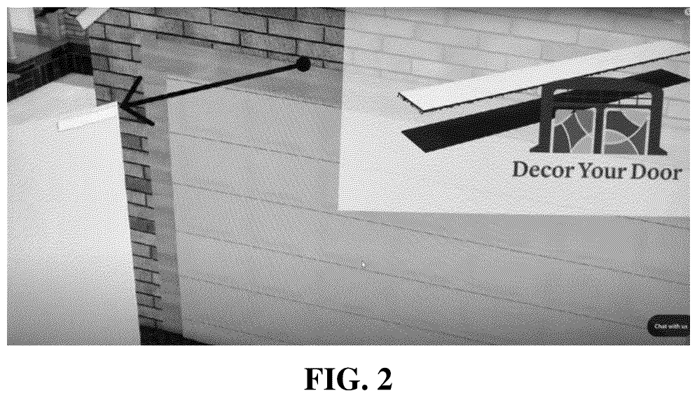

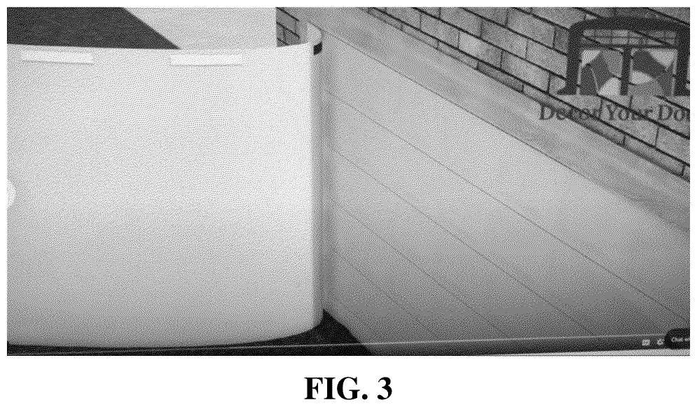

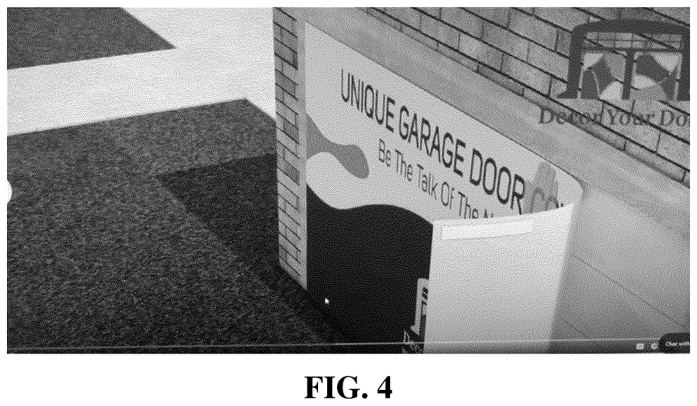

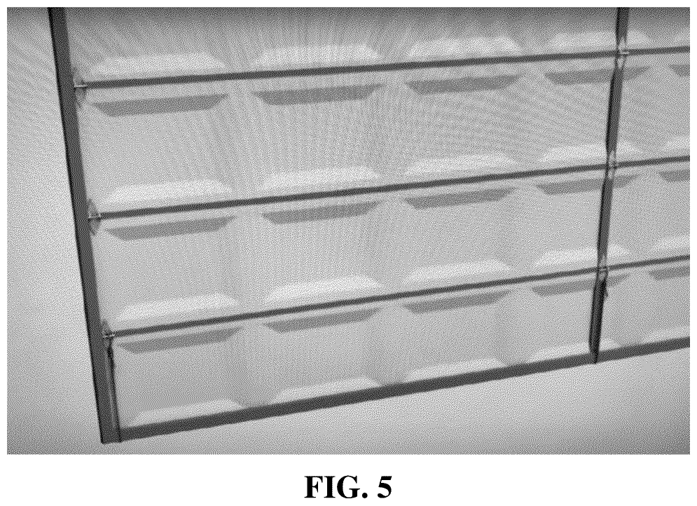

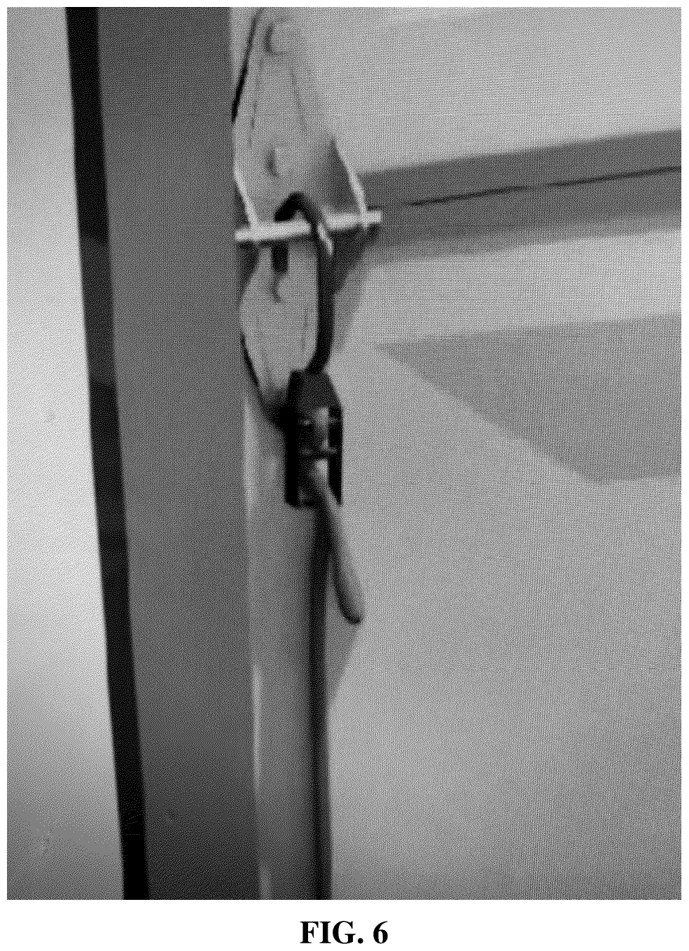

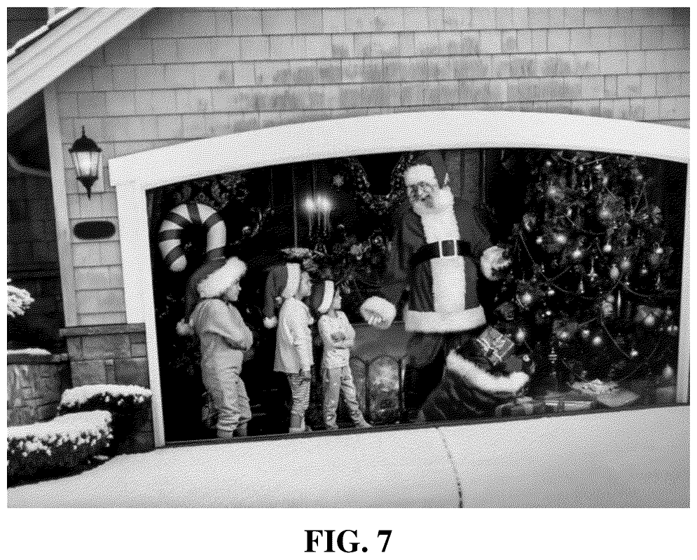

With reference generally to FIGS. 1-7, systems and methods for temporarily affixing a decorative cover to a hinged panel door are shown therein. As an initial step, it may be desirable to clean the exterior surface of the door in order to ensure that the adhesive backing of the hook and loop fastener adheres strongly to the door. A gentle solvent may be desired in order to avoid stripping paint from the door or corroding the door.

The rear surface of the decorative cover includes a plurality of sections of hook and loop fasteners and for ease of installation, both cooperative sides of the hook and loop are included. The rear surface of the hook and loop includes an adhesive backing covered by a protective paper. Once the door surface is prepared, the protective paper may be removed and the hook and loop sections can be carefully adhered to the door surface, preferably at the top of the door.

Once the hook and loop fasteners are adhered to the door, the decorative cover should be draped substantially over the door. The decorative cover can be removed by pulling the decorative cover from the hook or loop adhered to the door. This procedure should leave one cooperative section, either hook or loop, adhered to the door, and the other cooperative section remaining affixed to the back of the decorative cover. This facilitates replacement of the decorative cover as it wears, or for acknowledgement of changing seasons or holidays.

A plurality of elastic bands are attached to the bottom of the decorative cover, each terminating in a hook. In order to secure the bottom of the decorative cover to the door, the elastic band can be wrapped around the bottom of the door and secured to any hard point on the rear of the door, such as one of the hinges between the panels.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A decorative door cover comprising:
a banner including at least one indicia on a front face of said banner;
a plurality of LED lights disposed on said front face of said banner,
a plurality of spaced hook and loop fastener components disposed along a top portion of a rear face of said banner,
a plurality of elastic cords secured to a bottom edge of said banner, each of said plurality of elastic cords terminating in a hook.
